(19) United States
(12) Patent Application Publication
(10) Pub. No.: US 2021/0160512 A1
(43) Pub. Date: May 27, 2021

(54) SYSTEMS AND METHODS FOR OPTIMIZED SCENE-BASED VIDEO ENCODING

(71) Applicant: Facebook, Inc., Menlo Park, CA (US)

(72) Inventors: Yu Liu, Sunnyvale, CA (US); Pankaj Sethi, Los Altos, CA (US); Shankar Lakshmi Regunathan, Redmond, WA (US); Yun Zhang, Fremont, CA (US); Jae Kim, Los Gatos, CA (US); Qian Chen, San Jose, CA (US)

(21) Appl. No.: 16/691,571

(22) Filed: Nov. 21, 2019

(51) Int. Cl. H04N 19/179; H04N 19/147; H04N 21/2365

(52) U.S. Cl. CPC H04N 19/179; H04N 21/23655; H04N 19/147

(57) ABSTRACT

The disclosed computer-implemented method may include (1) receiving a video with scenes, (2) creating an encoded video having an overall bitrate by (a) determining, for each of the scenes, a rate-distortion model, (b) determining, for each of the scenes, a downsampling-distortion model, (c) using the rate-distortion models of the scenes to determine, for each of the scenes, a per-scene bitrate that satisfies the overall bitrate, (d) determining, for each of the scenes, a per-scene resolution for the scene based on the rate-distortion model of the scene and the downsampling-distortion model of the scene, and (e) creating, for each of the scenes, an encoded scene having the per-scene bitrate of the scene and the per-scene resolution of the scene, and (3) streaming the encoded video at the overall bitrate by streaming the encoded scene of one of the scenes. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for optimized scene-based video encoding and streaming, according to some embodiments.

FIG. 2 is a block diagram of an exemplary system for performing optimized scene-based video encoding, according to some embodiments.

FIG. 3 is a block diagram of an exemplary video having multiple scenes and an associated exemplary encoded video having multiple encoded scenes, according to some embodiments.

FIG. 4 is a flow diagram of an exemplary method for optimized scene-based video encoding, according to some embodiments.

FIG. 5 is a block diagram of an exemplary data flow for optimized scene-based video encoding, according to some embodiments.

FIGS. 6 and 7 are block diagrams of exemplary data flows for determining rate-distortion models, according to some embodiments.

FIGS. 8 and 9 are block diagrams of exemplary data flows for determining downsampling-distortion models, according to some embodiments.

FIG. 10 is a diagram of exemplary error curves, according to some embodiments.

FIG. 11 is a block diagram of an exemplary data flow for optimized scene-based video encoding, according to some embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Before streaming videos to client devices, conventional video-streaming services typically encode the videos at multiple bitrates and/or multiple resolutions in order to accommodate for the client devices' capabilities, the client devices' available bandwidths, and/or the general variability of the client devices' bandwidths. Early video-streaming services used fixed “bitrate ladders” (e.g., a fixed set of bitrate-resolution pairs) to encode videos at multiple bitrates. However, as the complexity of videos can differ drastically, the use of fixed bitrate ladders generally results in bits being over-allocated for simple videos and/or bits being under-allocated for complex videos. For at least this reason, many conventional video-streaming services perform various complexity-based optimizations when encoding videos to increase or maximize perceived quality for any particular bandwidth. However, conventional techniques for optimized video encoding have typically been very computationally expensive. For example, a conventional per-title encoding system may attempt to select an optimized bitrate ladder for each video it sees by (1) encoding the video at multiple bitrate-resolution pairs, (2) determining a quality metric of each bitrate-resolution pair, and (3) selecting the bitrate ladder (i.e., convex hull) that best optimizes the quality metric. While this per-title encoding system may achieve significant quality improvements, its iterative multi-pass approach and brute-force search for convex hulls comes at a high computational cost.

The present disclosure is generally directed to systems and methods for optimizing scene-based video encoding. As will be explained in greater detail below, embodiments of the present disclosure may, given an overall target bitrate for encoding a video having multiple scenes (or shots), optimize overall quality or minimize overall distortion of the video by varying the resolution and/or bitrate of each scene when encoding the video. In some examples, embodiments of the present disclosure may estimate a rate-distortion model and/or a downsampling-distortion model for each scene in a video and may use these models to dynamically allocate bits across the scenes and to determine an optimal resolution for each scene given the number of bits allocated to it. By determining an optimized per-scene bitrate and resolution for each scene in a video, the systems described herein may allocate bits across the scenes in the video without over-allocating bitrates to low-complexity scenes or under-allocating bitrates to high-complexity scenes. Moreover, by estimating rate-distortion models and downsampling-distortion models, the encoding methods and systems described herein may encode videos having multiple scenes without implementing any brute-force convex-hull searches, which may significantly reduce computational costs compared to systems that do.

Features from any of the embodiments described herein may be used in combination with one another in accordance with the general principles described herein. These and other embodiments, features, and advantages will be more fully understood upon reading the following detailed description in conjunction with the accompanying drawings and claims.

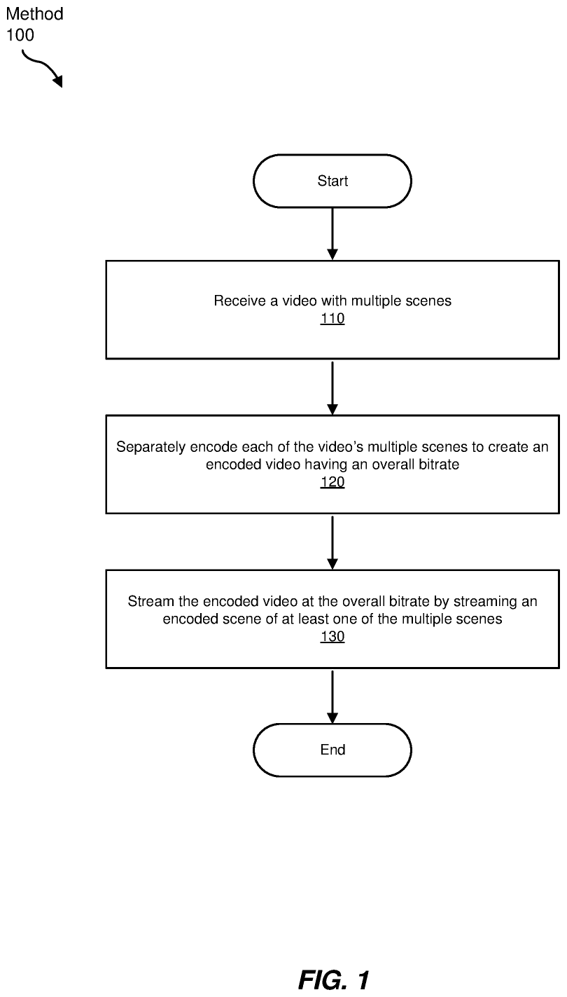

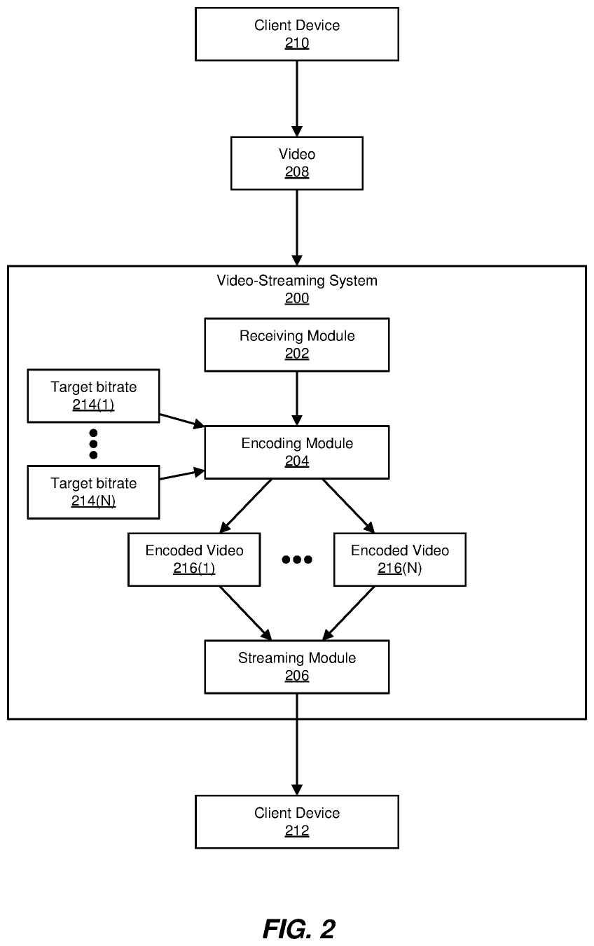

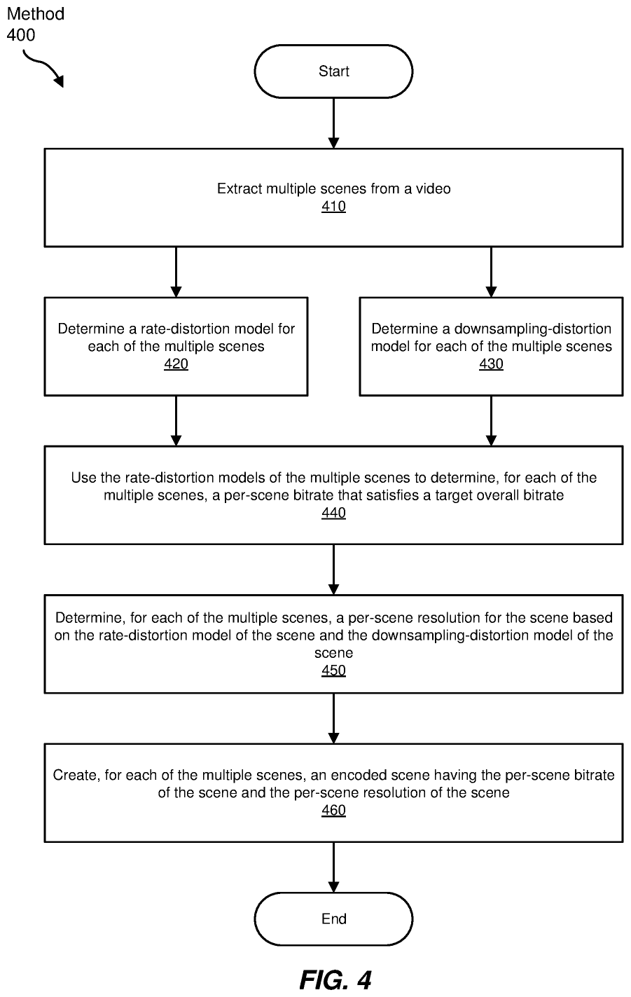

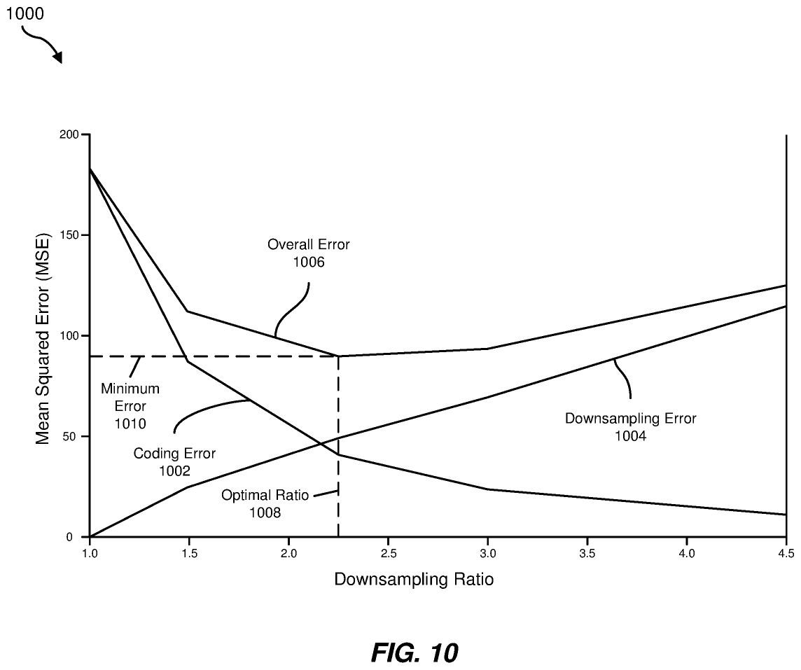

The following will provide, with reference to FIGS. 1 and 4, detailed descriptions of methods for optimized scene-based video encoding and/or streaming. The following will also provide, with reference to FIGS. 2, 3, 5-9, and 11, detailed descriptions of exemplary systems and data flows for performing optimized scene-based video encoding. Additionally, the following will provide, with reference to FIG. 10, descriptions of exemplary error curves.

FIG. 1 is a flow diagram of an exemplary computer-implemented method 100 for optimized scene-based video encoding and streaming. The steps shown in FIG. 1 may be performed by any suitable computer-executable code and/or computing system, including the system(s) and module(s) illustrated in FIGS. 2, 5, 6, 8, and 11. In one example, each of the steps shown in FIG. 1 may represent an algorithm whose structure includes and/or is represented by multiple sub-steps, examples of which will be provided in greater detail below.

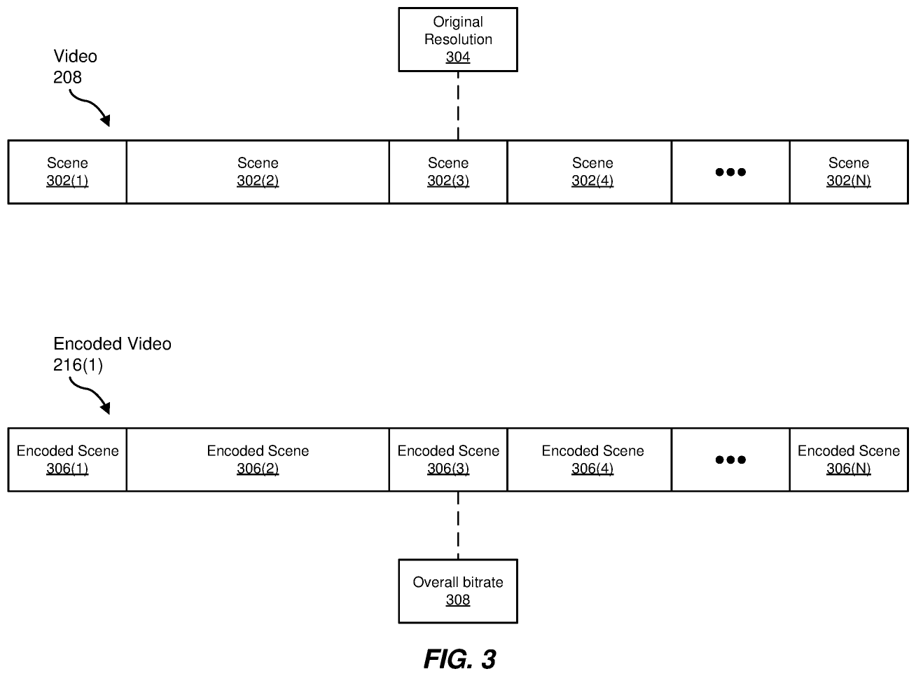

As illustrated in FIG. 1, at step 110 one or more of the systems described herein may receive a video with multiple scenes. For example, receiving module 202 of video-streaming system 200 may receive a video 208 from a client device 210. As shown in FIG. 3, video 208 may include multiple scenes 302(1)-(N) and may have an original resolution 304. In some embodiments, the term “scene” may refer to any continuous shot within a video. In some embodiments, the term “scene” may generally refer to any portion of a video whose characteristics differ from other portions of the video and/or any portion of a video whose characteristics are relatively constant, are relatively stable, or remain close to or within a particular range. Examples of characteristics that may define different scenes within a video include, without limitation, complexity, texture, motion, subjects, and content. In at least one embodiment, the term “scene” may refer to a single transcoded or encoded segment of a video (e.g., a segment of a video delineated by keyframes or Intra-coded (I) frames). As will be explained in greater detail below, since the contents of different scenes within a video may have different characteristics, the systems described herein may derive different rate-distortion models and different downsampling-distortion models for the different scenes.

As illustrated in FIG. 1, at step 120 one or more of the systems described herein may separately encode each of the video's multiple scenes to create an encoded video having an overall bitrate. For example, encoding module 204 of video-streaming system 200 may separately encode each of scenes 302(1)-(N) to create an encoded video 216(1) having a target bitrate 214(1). As shown in FIG. 3, encoded video 216(1) may have an overall bitrate 308 and may include multiple encoded scenes 306(1)-(N). In this example, an overall bitrate 308 may be equal to target bitrate 214(1), and encoded scenes 306(1)-(N) may respectively represent encodings of scenes 302(1)-(N) of video 208. In some embodiments, encoding module 206 may separately encode each of scenes 302(1)-(N) multiple times to create encoded videos 216(1)-(N) having overall target bitrates 214(1)-(N), respectively. As will be explained in greater detail below in connection with FIG. 4, the systems described herein may encode scenes 302(1)-(N) at different optimized per-scene bitrates and/or different optimized per-scene resolutions.

In some embodiments, the term “bitrate” may refer to the rate of data transfer over a network or digital connection. In these embodiments, a bitrate may be expressed as the number of bits transmitted per second, such as megabits per second (Mbps). Additionally, a bitrate may represent a network bandwidth (e.g., a current or available network bandwidth between system 200 and client device 212) and/or an expected speed of data transfer for videos over a network (e.g., an expected speed of data transfer for videos over a network that connects system 200 to client device 212).

As illustrated in FIG. 1, at step 130 one or more of the systems described herein may stream the encoded video at the overall bitrate by streaming an encoded scene of at least one of the multiple scenes. For example, streaming module 206 of video-streaming system 200 may stream encoded video 216(1) at target bitrate 214(1) by streaming one or more of encoded scenes 306(1)-(N).

In some embodiments, streaming module 206 may utilize multiple bitrates to stream a video in order to accommodate or adapt to changes in available bandwidth or to accommodate a user-selected bitrate. In some embodiments, streaming module 206 may stream a video to a client device at a first bitrate and a second bitrate by streaming a portion of an associated encoded video having an overall bitrate equal to the first bitrate and by streaming another portion of another associated encoded video having an overall bitrate equal to the second bitrate. Using FIG. 2 as an example, streaming module 206 may stream video 208 to client device 212 at two or more of bitrates 214(1)-(N) by streaming portions of two or more of encoded videos 216(1)-(N).

FIG. 4 is a flow diagram of an exemplary computer-implemented method 400 for optimized scene-based video encoding. The steps shown in FIG. 4 may be performed by any suitable computer-executable code and/or computing system, including the system(s) and module(s) illustrated in FIGS. 2, 5, 6, 8, and 11. In one example, each of the steps shown in FIG. 4 may represent an algorithm whose structure includes and/or is represented by multiple sub-steps, examples of which will be provided in greater detail below. In some examples, each of the steps shown in FIG. 4 may represent sub-steps of step 120 in FIG. 1.

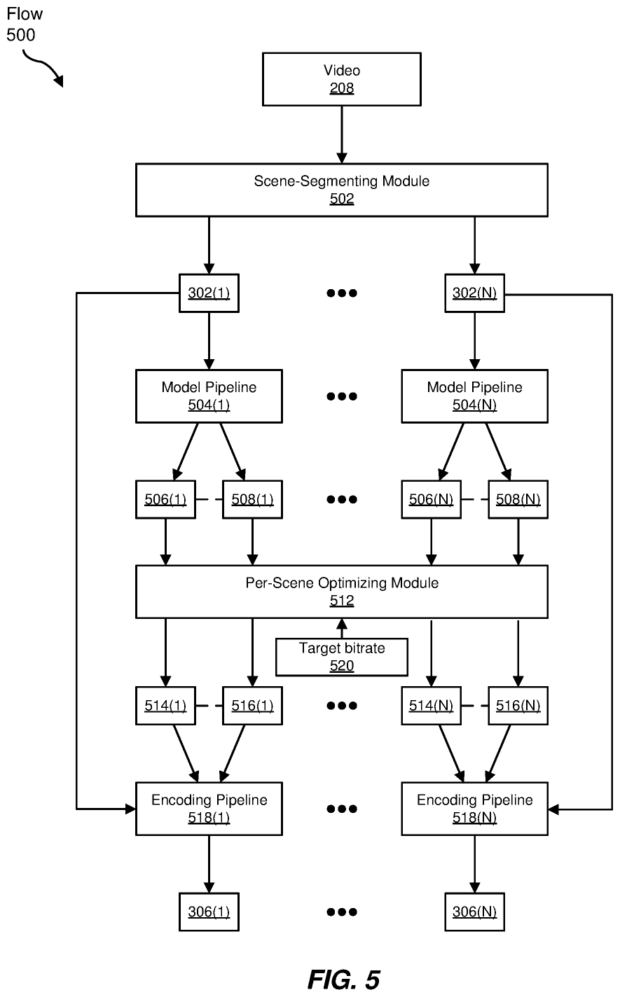

As illustrated in FIG. 4, at step 410 one or more of the systems described herein may extract multiples scenes from a video. For example, scene-segmenting module 502 may extract scenes 302(1)-(N) from video 208, as shown in data flow 500 in FIG. 5.

The systems described herein may perform step 410 in a variety of ways. In one example, the systems described herein may extract scenes from a video by extracting each continuous shot from the video (i.e., each shot represents one scene). In another example, the systems described herein may extract scenes from a video by splitting the video into Group Of Pictures (GOP) segments. In some embodiments, I frames (e.g., Instantaneous Decoder Refresh (IDR) frames) may mark the start of each GOP segment within a video, and the systems described herein may split the video into GOP segments by splitting the video according to the I frames. In at least one embodiment, the systems described herein may prepare a video for scene extraction by performing a client-side or server-side transcoding operation on the video that detects scenes and/or marks the scenes using I frames.

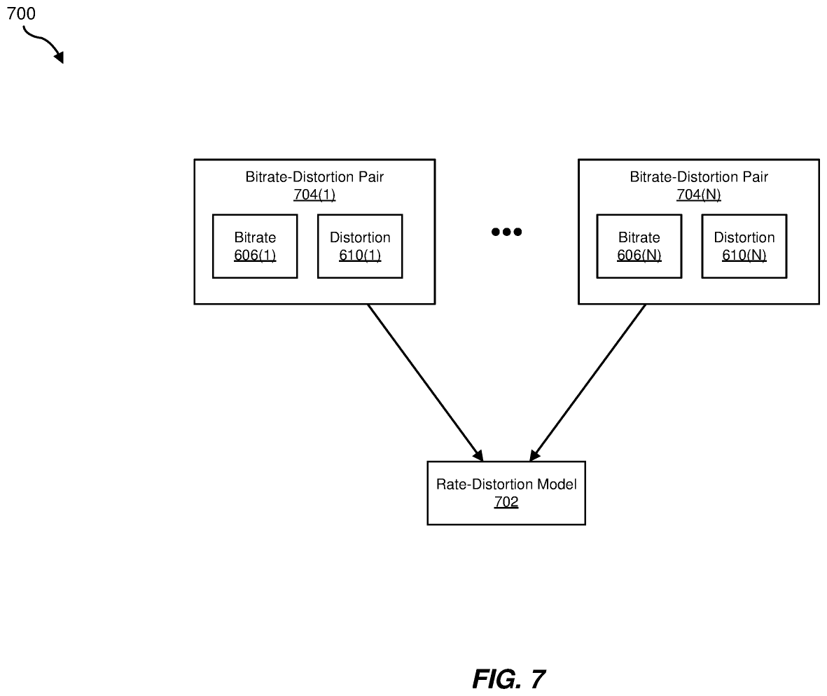

At step 420 one or more of the systems described herein may determine a rate-distortion model for each of the multiple scenes. For example, the systems described herein may use model pipelines 504(1)-(N) to determine rate-distortion models 506(1)-(N) for scenes 302(1)-(N), respectively. In some embodiments, the term “rate-distortion model” may refer to an algorithm, curve, heuristic, data, or combination thereof, that maps the bitrates at which a video or a scene may be encoded to estimates or measurements of the distortions or the qualities of the resulting encoded videos or scenes. Using FIG. 7 as an example, a rate-distortion model 702 may include bitrate-distortion pairs 704(1)-(N) each consisting of a bitrate and a corresponding distortion metric. In some embodiments, the term “rate-distortion model” may refer to a bitrate-quality model or a coding-distortion model.

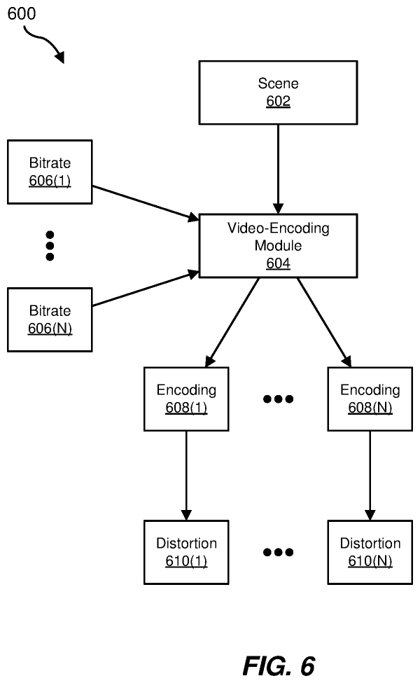

The systems described herein may perform step 420 in a variety of ways. In one example, the systems described herein may estimate a rate-distortion model of a scene using a predetermined number (e.g., as few as 4) of bitrate-distortion data points derived from the scene. For example, the systems described herein may estimate a rate-distortion model for a scene by (1) encoding the scene at a predetermined number of bitrates and/or at its original resolution and (2) measuring a distortion metric (e.g., a mean squared error (MSE) or Peak Signal-to-Noise Ratio (PSNR)) of each resulting encoded scene. Using data flows 600 and 700 in FIGS. 6 and 7 as an example, video-encoding module 604 may encode a scene 602 at each of bitrates 606(1)-(N) to create encodings 608(1)-(N), respectively. Video-encoding module 604 may then respectively measure distortions 610(1)-(N) of encodings 608(1)-(N). In one example, the systems described herein may generate bitrate-distortion pairs 704(1)-(N) from bitrates 606(1)-(N) and distortions 610(1)-(N) and may use bitrate-distortion pairs 704(1)-(N) to construct or derive rate-distortion model 702.

In some embodiments, a rate-distortion model fora scene may be represented by equation (1) or equation (2), wherein R represents a scene's bitrate, r represents the number of bits allocated to each pixel (e.g., bits per pixel (bpp)) according to equation (3), where F represents a scene's frame rate, where Wand H represent the scene's width and height, and where and a are content-dependent parameters.

$$\begin{matrix}D = \frac{β}{{R}^{α}} & ( 1 ) \\ D = \frac{β}{{r}^{α}} & ( 2 ) \\ r = \frac{R}{F \times W \times H} & ( 3 )\end{matrix}$$

In some embodiments, the systems described herein may estimate β and α for a scene by (1) encoding the scene at a predetermined number of bitrates {R₀, R₁, R₂, . . . , R_{N-1}}, (2) measuring a distortion metric (e.g., a mean squared error (MSE) or Peak Signal-to-Noise Ratio (PSNR)) of each resulting encoded video to get a corresponding set of distortions {D₀, D₁, D₂, . . . , D_{N-1}}, normalizing bitrates {R₀, R₁, R₂, . . . , R_{N-1}} to bpps {r₀, r₁, r₂, . . . , r_{N-1}}, normalizing {D₀, D₁, D₂, . . . , D_{N-1}} to {d₀, d₁, d₂, . . . , d_{N-1}}, and solving equation (4).

$$[ {β}_{opt} , {α}_{opt} ] = arg {min}_{β , α} {\sum }_{i = 0}^{N - 1} {( {d}_{i} - \frac{β}{{{r}_{i}}^{α}} )}^{2} \qquad ( 4 )$$

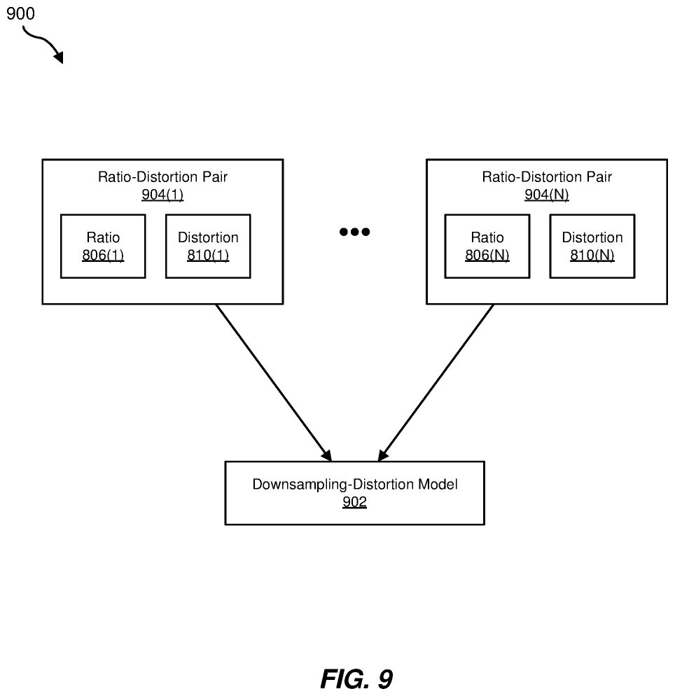

At step 430 one or more of the systems described herein may determine a downsampling-distortion model for each of the multiple scenes. For example, the systems described herein may use model pipelines 504(1)-(N) to determine downsampling-distortion models 508(1)-(N) for scenes 302(1)-(N), respectively. In some embodiments, the term “downsampling-distortion model” may refer to an algorithm, curve, heuristic, data, or combination thereof, that maps downsampling ratios (or resolutions) at which a video or a scene may be downsampled to estimates or measurements of the distortions or the qualities of the resulting encoded videos or scenes. Using FIG. 9 as an example, a downsampling-distortion model 902 may include ratio-distortion pairs 704(1)-(N) each consisting of a downsampling ratio and a corresponding distortion metric. In some embodiments, the term “downsampling-distortion model” may refer to a resolution-quality model or a downsampling-error model.

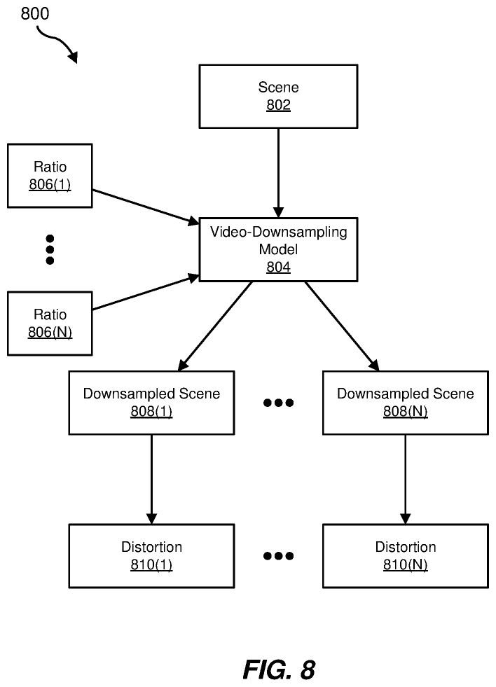

The systems described herein may perform step 430 in a variety of ways. In one example, the systems described herein may estimate a downsampling-distortion model for a scene by (1) downsampling the scene at a predetermined number of downsampling ratios and (2) measuring a distortion metric (e.g., a mean squared error (MSE)) or of each resulting encoded scene. Using data flows 800 and 900 in FIGS. 8 and 9 as an example, video-downsampling module 804 may downsample a scene 802 at each of downsampling ratios 806(1)-(N) to create downsampled scenes 808(1)-(N), respectively. Video-downsampling module 804 may then respectively measure distortions 810(1)-(N) of downsampled scenes 808(1)-(N). In one example, the systems described herein may generate ratio-distortion pairs 904(1)-(N) from downsampling ratios 806(1)-(N) and distortions 810(1)-(N) and may use ratio-distortion pairs 904(1)-(N) to construct or derive downsampling-distortion model 902.

In some embodiments, the systems disclosed herein may use a suitable encoding, transcoding, or downsampling tool or application to directly calculate downsampling errors for a predetermined number of target downsampling resolutions (e.g., 720p, 480p, 360p, 240p, 144p, etc.) and may use the calculated downsampling errors to estimate a downsampling-distortion model. In some embodiments, the systems disclosed herein may model downsampling errors using a suitable frequency-domain analysis technique.

Steps 420 and 430 may be performed in any order, in series, or in parallel. For example, data flow 600 in FIG. 6 may be performed in parallel with data flow 800 in FIG. 8. In some embodiments (e.g., as shown in FIG. 5), multiple parallelized pipelines may be used to determine rate-distortion models and downsampling-distortion models for scenes within a multi-scene video. In at least one example, each of model pipelines 504(1)-(N) may include data flows similar to data flows 600-900 in FIGS. 6-9. Scenes within a video may have different characteristics (e.g., complexities). For at least this reason, the systems described herein may determine a different rate-distortion model for each unique scene and a different downsampling-distortion model for each unique scene. In some embodiments, the systems described herein may combine a scene's rate-distortion and downsampling-distortion models to model relationships between bitrates, complexities, and/or qualities.

At step 440 one or more of the systems described herein may use the rate-distortion models of the multiple scenes to determine, for each of the multiple scenes, a per-scene bitrate that satisfies a target overall bitrate. For example, per-scene optimizing module 512 may use rate-distortion models 506(1)-(N) of scenes 302(1)-(N) to determine per-scene bitrates 514(1)-(N) for scenes 302(1)-(N), respectively, that satisfy a target overall bitrate 520 (e.g., one of target bitrates 214(1)-(N)).

The systems described herein may perform step 440 in a variety of ways. In general, the systems described herein may consider the per-scene bitrates of the scenes within a video as satisfying a target overall bitrate for the video if the per-scene bitrates satisfy equation (5), where N is the number of scenes in the video, where duration₁ is the duration of the i^{th} scene, where Rᵢ is the per-scene bitrate of the i^{th} scene, where durationₜₒₜₐₗ is the total duration of the video, and where R_{target} is the overall target bitrate for the video.

$$\frac{1}{{duration}_{total}} {\sum }_{i = 0}^{N - 1} {R}_{i} \times {duration}_{i} \leq {R}_{target} \qquad ( 5 )$$

In some embodiments, the systems described herein may use the rate-distortion models of the scenes within a video to calculate per-scene bitrates for the scenes that both satisfy a target overall bitrate and achieve a particular average quality or distortion for the entire video. Alternatively, the systems described herein may use the rate-distortion models of the scenes within a video to calculate per-scene bitrates for the scenes that both satisfy a target overall bitrate and achieve a particular constant quality or distortion for the entire video.

In some embodiments, the systems described herein may allocate bits across the scenes of a video by solving equation (6) subject to equations (5), (7), (8), (9), and/or (10) (e.g., using a constrained minimization method, such as Sequential Least Squares Programming (SLSQP)), where N is the number of scenes in the video, where Dᵢ is a distortion of the i^{th} scene, where duration₁ is the duration of the i^{th} scene, where Rᵢ is the per-scene bitrate of the i^{th} scene, where βᵢ and αᵢ are content-dependent parameters of the i^{th} scene, where durationₜₒₜₐₗ is the total duration of the video, where R_{target} is the overall target bitrate for the video, where high_bound_ratio is an upper-bound ratio (e.g., 1.5), and where low_bound_ratio is a lower-bound ratio (e.g., 0.5). In some examples, high_bound_ratio and low_bound_ratio may be selected to prevent overflow or underflow issues.

$$\begin{matrix}min {\sum }_{i = 0}^{N - 1} {D}_{i} \times {duration}_{i} & ( 6 ) \\ {D}_{i} = \frac{{β}_{i}}{{{R}_{i}}^{{α}_{i}}} & ( 7 ) \\ \frac{1}{{duration}_{total}} {\sum }_{i = 0}^{N - 1} {R}_{i} \times {duration}_{i} = {R}_{target} & ( 8 ) \\ {R}_{i} \leq {R}_{target} \times high\_bound \_ratio & ( 9 ) \\ {R}_{i} \geq {R}_{target} \times low\_bound \_ratio & ( 10 )\end{matrix}$$

At step 450 one or more of the systems described herein may determine, for each of the multiple scenes, a per-scene resolution for the scene based on the rate-distortion model of the scene and the downsampling-distortion model of the scene. For example, per-scene optimizing module 512 may use rate-distortion models 506(1)-(N) and downsampling-distortion models 508(1)-(N) of scenes 302(1)-(N) to determine per-scene resolutions 516(1)-(N) for scenes 302(1)-(N), respectively.

The systems described herein may perform step 450 in a variety of ways. In one example, the systems described herein may use a rate-distortion model of a scene and a downsampling-distortion model of a scene to determine, given a target bitrate (e.g., the per-scene bitrate determined at step 440), an optimal downsampling ratio or resolution for the scene that maximizes overall quality or minimizes overall distortion of the scene. In some embodiments, overall distortion may be equal to, given a particular bitrate, a sum of a coding error or distortion resulting from an encoding operation and a downsampling error or distortion resulting from a downsampling operation. The systems described herein may therefore use a rate-distortion model of a scene to estimate coding distortions and a downsampling-distortion model of the scene to estimate downsampling distortions.

Graph 1000 in FIG. 10 illustrates an exemplary coding error curve 1002, an exemplary downsampling error curve 1004, and an exemplary overall error curve 1006 (i.e., a sum of coding error curve 1002 and downsampling error curve 1004) for a particular scene. In some embodiments, the systems described herein may derive the curves shown in FIG. 10 using the scene's rate-distortion and downsampling-distortion models. As illustrated in FIG. 10, coding error curve 1002 may monotonically decrease with downsampling ratio. On the other hand, downsampling error curve 1004 may monotonically increase with downsampling ratio. In the example shown, the systems described herein may determine an optimal downsampling ratio 1008 by determining that overall error 1006 is at a minimum error 1010 at downsampling ratio 1008.

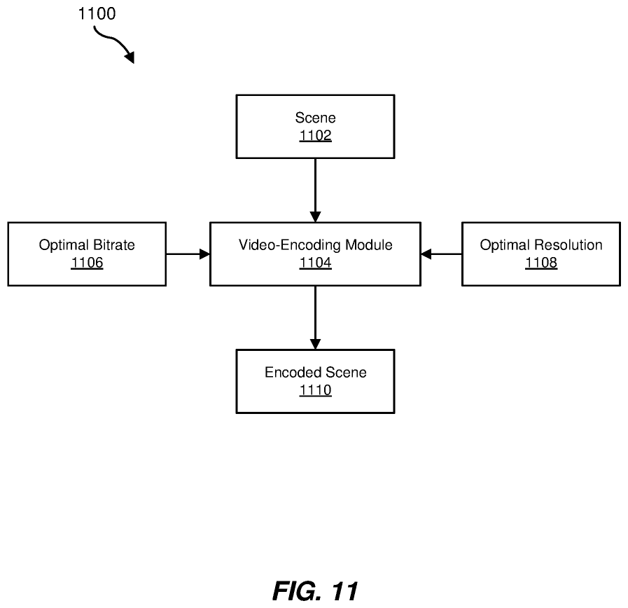

At step 460 one or more of the systems described herein may create, for each of the multiple scenes, an encoded scene having the per-scene bitrate of the scene and the per-scene resolution of the scene. For example, the systems described herein may create encoded scenes 306(1)-(N) by respectively using encoding pipelines 518(1)-(N) to encode each of scenes 302(1)-(N) at its respective per-scene bitrate and per-scene resolution. In some examples, each of encoding pipelines 518(1)-(N) may take as input a scene, an optimal bitrate for the scene, and an optimal resolution for the scene and output an encoded scene at the optimal bitrate and resolution. For example, as illustrated by data flow 1100 in FIG. 11, a video-encoding module 1104 may take as input a scene 1102, an optimal bitrate 1106 for scene 1102 (e.g., as determined at step 440), and an optimal resolution 1108 for scene 1102 (e.g., as determined at step 450) and may output an encoded scene 1110 having optimal bitrate 1106 and optimal resolution 1108.

As explained above, embodiments of the present disclosure may, given an overall target bitrate for encoding a video having multiple scenes (or shots), optimize overall quality or minimize overall distortion of the video by varying the resolution and/or bitrate of each scene when encoding the video. In some examples, embodiments of the present disclosure may estimate a rate-distortion model and/or a downsampling-distortion model for each scene in a video and may use these models to dynamically allocate bits across the scenes and to determine an optimal resolution for each scene given the number of bits allocated to it. By determining an optimized per-scene bitrate and resolution for each scene in a video, the systems described herein may allocate bits across the scenes in the video without over-allocating bitrates to low-complexity scenes or under-allocating bitrates to high-complexity scenes. Moreover, by estimating rate-distortion models and downsampling-distortion models, the encoding methods and systems described herein may encode videos having multiple scenes without implementing any brute-force convex-hull searches, which may significantly reduce computational costs compared to systems that do.

### EXAMPLE EMBODIMENTS

Example 1: A computer-implemented method including (1) receiving a video comprising multiple scenes, (2) creating, from the video, an encoded video having an overall bitrate by (a) determining, for each of the multiple scenes, a rate-distortion model, (b) determining, for each of the multiple scenes, a downsampling-distortion model, (c) using the rate-distortion models of the multiple scenes to determine, for each of the multiple scenes, a per-scene bitrate that satisfies the overall bitrate, (d) determining, for each of the multiple scenes, a per-scene resolution for the scene based on the rate-distortion model of the scene and the downsampling-distortion model of the scene, and (e) creating, for each of the multiple scenes, an encoded scene having the per-scene bitrate of the scene and the per-scene resolution of the scene, and (3) streaming the encoded video at the overall bitrate by streaming the encoded scene of at least one of the multiple scenes.

Example 2: The computer-implemented method of Example 1, wherein the overall bitrate is a target overall bitrate for streaming the video and using the rate-distortion models of the multiple scenes includes using the rate-distortion models of the multiple scenes to allocate bits across the multiple scenes to achieve maximal quality over all the multiple scenes given the target overall bitrate.

Example 3: The computer-implemented method of any of Examples 1-2, wherein the overall bitrate is a target overall bitrate for streaming the video and using the rate-distortion models of the multiple scenes includes using the rate-distortion models of the multiple scenes to allocate bits across the multiple scenes to achieve a constant quality given the target overall bitrate.

Example 4: The computer-implemented method of any of Examples 1-3, wherein the per-scene bitrate of each of the multiple scenes is equal to the overall bitrate.

Example 5: The computer-implemented method of any of Examples 1-4, wherein (1) the rate-distortion model of each of the multiple scenes uniquely estimates, for a range of bitrates, distortions of the scene caused by an encoding mechanism and (2) the downsampling-distortion model of each of the multiple scenes uniquely estimates, for a range of downsampling ratios, distortions of the scene caused by a downsampling mechanism.

Example 6: The computer-implemented method of any of Examples 1-5, wherein determining, for each of the multiple scenes, the per-scene resolution for the scene includes using the rate-distortion model of the scene and the downsampling-distortion model of the scene to determine a downsampling ratio that minimizes an overall distortion of the scene, the overall distortion of the scene being a summation of a coding error derived from the rate-distortion model and a downsampling error derived from the downsampling-distortion model.

Example 7: The computer-implemented method of any of Examples 1-6, wherein the rate-distortion model and the downsampling-model of any single one of the multiple scenes are determined by a single parallelizable pipeline.

Example 8: The computer-implemented method of any of Examples 1-7, wherein the rate-distortion model and the downsampling-model of each of the multiple scenes are determined by parallel pipelines.

Example 9: The computer-implemented method of any of Examples 1-8, wherein (1) the video has an original resolution and (2) determining the rate-distortion model for one of the multiple scenes includes (a) encoding the scene at multiple bitrates to create multiple encoded scenes at the original resolution and (b) estimating the rate-distortion model based on a distortion of each of the multiple encoded scenes.

Example 10: The computer-implemented method of any of Examples 1-9, wherein (1) the video has an original resolution and (2) determining the rate-distortion model for one of the multiple scenes includes (a) encoding the scene at only four different bitrates to create four encoded scenes at the original resolution and (b) estimating the rate-distortion model based on a distortion of each of the four encoded scenes.

Example 11: The computer-implemented method of any of Examples 1-10, wherein (1) the video has an original resolution and (2) determining the downsampling-distortion model for each of the multiple scenes includes (a) downsampling, from the original resolution, the scene at multiple ratios to create multiple downsampled scenes and (b) estimating the downsampling-distortion model based on a distortion of each of the multiple downsampled scenes.

Example 12: A system including at least one physical processor and physical memory including computer-executable instructions that, when executed by the physical processor, cause the physical processor to (1) receive a video having multiple scenes, (2) create, from the video, an encoded video having an overall bitrate by (a) determining, for each of the multiple scenes, a rate-distortion model, (b) determining, for each of the multiple scenes, a downsampling-distortion model, (c) using the rate-distortion models of the multiple scenes to determine, for each of the multiple scenes, a per-scene bitrate that satisfies the overall bitrate, (d) determining, for each of the multiple scenes, a per-scene resolution for the scene based on the rate-distortion model of the scene and the downsampling-distortion model of the scene, and (e) creating, for each of the multiple scenes, an encoded scene having the per-scene bitrate of the scene and the per-scene resolution of the scene, and (3) stream the encoded video at the overall bitrate by streaming the encoded scene of at least one of the multiple scenes.

Example 13: The system of Example 12, wherein the overall bitrate is a target overall bitrate for streaming the video and using the rate-distortion models of the multiple scenes includes using the rate-distortion models of the multiple scenes to allocate bits across the multiple scenes to achieve maximal quality over all the multiple scenes given the target overall bitrate.

Example 14: The system of any of Examples 12-13, wherein the overall bitrate is a target overall bitrate for streaming the video and using the rate-distortion models of the multiple scenes includes using the rate-distortion models of the multiple scenes to allocate bits across the multiple scenes to achieve a constant quality given the target overall bitrate.

Example 15: The system of any of Examples 12-14, wherein (1) the rate-distortion model of each of the multiple scenes uniquely estimates, for a range of bitrates, distortions of the scene caused by an encoding mechanism and (2) the downsampling-distortion model of each of the multiple scenes uniquely estimates, for a range of downsampling ratios, distortions of the scene caused by a downsampling mechanism.

Example 16: The system of any of Examples 12-15, wherein the rate-distortion model and the downsampling-model of each of the multiple scenes are determined in parallel.

Example 17: The system of any of Examples 12-16, wherein (1) the video has an original resolution and (2) determining the rate-distortion model for one of the multiple scenes includes (a) encoding the scene at multiple bitrates to create multiple encoded scenes at the original resolution and (b) estimating the rate-distortion model based on a distortion of each of the multiple encoded scenes.

Example 18: The system of any of Examples 12-17, wherein (1) the video has an original resolution and (2) determining the rate-distortion model for one of the multiple scenes includes (a) encoding the scene at only four different bitrates to create four encoded scenes at the original resolution and (b) estimating the rate-distortion model based on a distortion of each of the four encoded scenes.

Example 19: The system of any of Examples 12-18, wherein (1) the video has an original resolution and (2) determining the downsampling-distortion model for each of the multiple scenes includes (a) downsampling, from the original resolution, the scene at multiple ratios to create multiple downsampled scenes and (b) estimating the downsampling-distortion model based on a distortion of each of the multiple downsampled scenes.

Example 20: A non-transitory computer-readable medium may include one or more computer-executable instructions that, when executed by at least one processor of a computing device, cause the computing device to (1) receive a video comprising multiple scenes, (2) create, from the video, an encoded video having an overall bitrate by (a) determining, for each of the multiple scenes, a rate-distortion model, (b) determining, for each of the multiple scenes, a downsampling-distortion model, (c) using the rate-distortion models of the multiple scenes to determine, for each of the multiple scenes, a per-scene bitrate that satisfies the overall bitrate, (d) determining, for each of the multiple scenes, a per-scene resolution for the scene based on the rate-distortion model of the scene and the downsampling-distortion model of the scene, and (e) creating, for each of the multiple scenes, an encoded scene having the per-scene bitrate of the scene and the per-scene resolution of the scene, and (3) stream the encoded video at the overall bitrate by streaming the encoded scene of at least one of the multiple scenes.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive a video having multiple scenes to be transformed, transform the video into an encoded video having multiple optimized encoded scenes, output a result of the transformation to a video-streaming system, use the result of the transformation to stream the video to one or more clients, and store the result of the transformation to a video-storage system. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method comprising:
receiving a video comprising multiple scenes;
creating, from the video, an encoded video having an overall bitrate by:
generating, for each of the multiple scenes, a rate-distortion model from the scene;
generating, for each of the multiple scenes, a downsampling-distortion model from the scene;
using the rate-distortion models of the multiple scenes to determine, for each of the multiple scenes, a per-scene bitrate that satisfies the overall bitrate;
determining, for each of the multiple scenes, a per-scene resolution for the scene based on the rate-distortion model generated from the scene and the downsampling-distortion model generated from the scene; and
creating, for each of the multiple scenes, an encoded scene having the per-scene bitrate of the scene and the per-scene resolution of the scene; and
streaming the encoded video at the overall bitrate by streaming the encoded scene of at least one of the multiple scenes.
